(19) United States
(12) Patent Application Publication
(10) Pub. No.: US 2026/0046947 A1
(43) Pub. Date: Feb. 12, 2026

(54) TERMINAL DEVICE AND NETWORK DEVICE

(71) Applicant: GUANGDONG OPPO MOBILE TELECOMMUNICATIONS CORP., LTD., Dongguan (CN)

(72) Inventors: Yali GUO, Dongguan (CN); Boren GUO, Dongguan (CN)

(21) Appl. No.: 19/365,615

(22) Filed: Oct. 22, 2025

Related U.S. Application Data
(63) Continuation of application No. PCT/CN2023/100025, filed on Jun. 13, 2023.

(51) Int. Cl. H04W 76/10; H04W 8/22

(52) U.S. Cl. CPC H04W 76/10; H04W 8/22

(57) ABSTRACT

Communication methods and devices are provided, where the communication method includes: a terminal device sends a data unit set handling capability to a first network device, and the first network device receives the data unit set handling capability from the terminal device.

### CROSS REFERENCE TO RELATED APPLICATION(S)

This application is a continuation of International Application No. PCT/CN2023/100025, filed on Jun. 13, 2023, the entire disclosure of which is incorporated herein by reference.

### TECHNICAL FIELD

This application relates to the field of communication, and more particularly, to a terminal device and a network device.

### BACKGROUND

To support transmission optimization, a core-network network element can determine multiple data packets belonging to one frame or one coding slice; these data packets may be referred to as belonging to one data unit set, so that the network can perform unified handling on multiple data packets belonging to one data unit set. To support processing of a data unit set, the core-network device will send parameters of the data unit set to the access-network device; the parameters of the data unit set apply both to uplink data and to downlink data. However, data unit set handling for uplink data requires support from the terminal device, and not every terminal device supports data unit set handling, which results in the access-network device being unable to effectively process data sent by a terminal device that supports data unit set handling.

### SUMMARY

An embodiment of the disclosure provides a terminal device, including a processor, a memory, and a transceiver. The memory is configured to store a computer program, and the processor is configured to invoke and run the computer program stored in the memory and control the transceiver, to make the transceiver send a data unit set handling capability to a first network device.

An embodiment of the disclosure further provides a network device, including a processor, a memory, and a transceiver. The memory is configured to store a computer program, and the processor is configured to invoke and run the computer program stored in the memory and control the transceiver, to make the transceiver receive a data unit set handling capability from a terminal device.

### BRIEF DESCRIPTION OF THE DRAWINGS

FIG. 1 is a schematic diagram of an application scenario of an embodiment of the disclosure.

FIG. 2A is a first schematic diagram of a 5G network system architecture.

FIG. 2B is a second schematic diagram of a 5G network system architecture.

FIG. 3 is a schematic flow chart of a communication method 300 according to an embodiment of the disclosure.

FIG. 4 is a schematic flow chart of a communication method 400 according to an embodiment of the disclosure.

FIG. 5 is a schematic flow chart of a communication method 500 according to an embodiment of the disclosure.

FIG. 6 is a schematic flow chart of a communication method 600 according to an embodiment of the disclosure.

FIG. 7 is a flow chart of embodiment 1 of a communication method according to an embodiment of the disclosure.

FIG. 8 is a flow chart of embodiment 2 of a communication method according to an embodiment of the disclosure.

FIG. 9 is a flow chart of embodiment 3 of a communication method according to an embodiment of the disclosure.

FIG. 10 is a schematic structural diagram of a terminal device 1000 according to an embodiment of the disclosure.

FIG. 11 is a schematic structural diagram of a terminal device 1100 according to an embodiment of the disclosure.

FIG. 12 is a schematic structural diagram of a first network device 1200 according to an embodiment of the disclosure.

FIG. 13 is a schematic structural diagram of a first network device 1300 according to an embodiment of the disclosure.

FIG. 14 is a schematic structural diagram of a first network element 1400 according to an embodiment of the disclosure.

FIG. 15 is a schematic structural diagram of a first network element 1500 according to an embodiment of the disclosure.

FIG. 16 is a schematic structural diagram of a second network element 1600 according to an embodiment of the disclosure.

FIG. 17 is a schematic structural diagram of a second network element 1700 according to an embodiment of the disclosure.

FIG. 18 is a schematic structural diagram of a communication device 1800 according to an embodiment of the disclosure.

FIG. 19 is a schematic structural diagram of a chip 1900 according to an embodiment of the disclosure.

### DETAILED DESCRIPTION

The technical solutions in the embodiments of the disclosure will be described below in conjunction with the accompanying drawings in the embodiments of the disclosure.

It should be noted that, in the specification and the claims of the embodiments of the disclosure as well as in the above-mentioned drawings, the terms “first”, “second”, etc. are used for distinguishing similar objects and do not necessarily describe a specific order or sequence. Objects described as “first” and “second” may be the same or different.

The technical solutions of the embodiments of the disclosure may be applied to various communication systems, for example: a global system for mobile communication (GSM) system, a code division multiple access (CDMA) system, a wideband code division multiple access (WCDMA) system, general packet radio service (GPRS), a long term evolution (LTE) system, an advanced long term evolution (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), wireless fidelity (WiFi), a fifth-generation (5G) system or other communication systems.

Generally, traditional communication systems support a limited number of connections and are easy to implement; however, with the development of communication technology, mobile communication systems will not only support traditional communication but will also support, for example, device-to-device (D2D) communication, machine-to-machine (M2M) communication, machine type communication (MTC), vehicle-to-vehicle (V2V) communication, or vehicle-to-everything (V2X) communication, and the embodiments of the disclosure may also be applied to these communication systems.

In one embodiment, the communication system in the embodiments of the disclosure may be applied to a carrier aggregation (CA) scenario, may also be applied to a dual connectivity (DC) scenario, and may also be applied to a standalone (SA) networking scenario.

In one embodiment, the communication system in the embodiments of the disclosure may be applied to an unlicensed spectrum, where the unlicensed spectrum may also be regarded as a shared spectrum; or, the communication system in the embodiments of the disclosure may also be applied to a licensed spectrum, where the licensed spectrum may also be regarded as a non-shared spectrum.

The embodiments of the disclosure describe various embodiments in conjunction with network devices and terminal devices, where the terminal device may also be referred to as user equipment (UE), an access terminal, a subscriber unit, a subscriber station, a mobile station, a mobile set, a remote station, a remote terminal, a mobile device, a user terminal, a terminal, a wireless communication device, a user agent, or a user device, etc.

A terminal device may be a station (STA) in a WLAN, may be a cellular telephone, a cordless telephone, a session initiation protocol (SIP) telephone, a wireless local loop (WLL) station, a personal digital assistant (PDA) device, a handheld device with wireless communication capability, a computing device, or another processing device connected to a wireless modem, an in-vehicle device, a wearable device, a terminal device in a next-generation communication system such as an NR network, or a terminal device in a future evolved public land mobile network (PLMN) network, etc.

In the embodiments of the disclosure, a terminal device may be deployed on land, including indoor or outdoor, handheld, wearable, or in-vehicle; may also be deployed on water (such as on ships); and may also be deployed in the air (for example on airplanes, balloons, and satellites).

In the embodiments of the disclosure, a terminal device may be a mobile phone, a tablet computer (Pad), a computer with wireless transceiver capability, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, or a wireless terminal device in smart home, etc.

As an example and not a limitation, in the embodiments of the disclosure, the terminal device may also be a wearable device. A wearable device may also be called a wearable smart device, which is a general term for devices that apply wearable technology to intelligently design and develop daily wear, such as glasses, gloves, watches, clothing, and shoes. A wearable device is worn directly on the body or integrated into a user's clothing or accessories. A wearable device is not only a hardware device, but also achieves powerful functions through software support, data interaction, and cloud interaction. Broadly speaking, wearable smart devices include devices that have full functionality and large size and can realize complete or partial functions without relying on smartphones, such as smart watches or smart glasses, and also include devices that focus on a certain type of application function and need to be used together with other devices such as smartphones, such as various smart bracelets and smart jewelry for sign monitoring.

In the embodiments of the disclosure, a network device may be a device used to communicate with a mobile device, may be an access point (AP) in a WLAN, a base transceiver station (BTS) in GSM or CDMA, may also be a NodeB (NB) in WCDMA, may also be an evolutional NodeB (eNB or eNodeB) in LTE, or a relay station or an access point, or an in-vehicle device, a wearable device, and a network device (gNB) in an NR network or a network device in a future evolved PLMN network or a network device in an NTN network, etc.

As an example and not a limitation, in the embodiments of the disclosure, the network device may have mobility characteristics, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station located on land, on water, etc.

In the embodiments of the disclosure, a network device may provide services for a cell, and a terminal device communicates with the network device using transmission resources (for example, frequency domain resources, or in other words, spectrum resources) of the cell; the cell may be a cell corresponding to a network device (for example a base station), and the cell may belong to a macro base station or to a small-cell base station. Here, the small cell may include: a metro cell, a micro cell, a pico cell, a femto cell, etc. These small cells have a small coverage range and low transmit power, and are suitable for providing high-rate data transmission services.

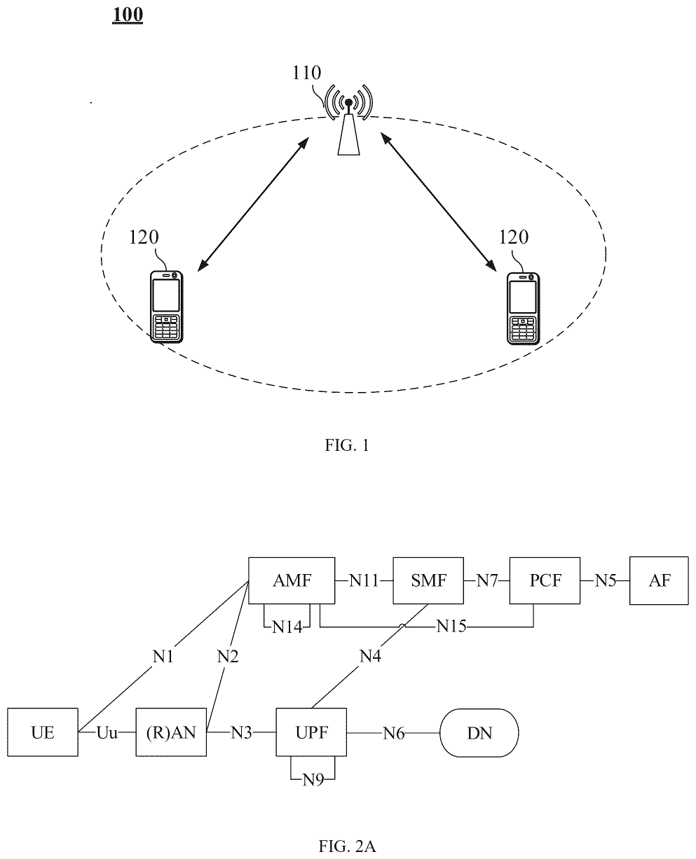

FIG. 1 illustratively shows a communication system 100. The communication system includes one network device 110 and two terminal devices 120. In one embodiment, the communication system 100 may include multiple network devices 110, and in the coverage of each network device 110, there may be other numbers of terminal devices 120, which is not limited in the embodiments of the disclosure.

In one embodiment, the communication system 100 may further include other network entities such as a mobility management entity (MME), an access and mobility management function (AMF), etc., which is not limited in the embodiments of the disclosure.

The network device may further include an access-network device and a core-network device. That is, the wireless communication system further includes multiple core networks for communicating with the access-network device. The access-network device may be an evolutional NodeB (eNB or e-NodeB) macro base station, a micro base station (also called “small base station”), a pico base station, an access point (AP), a transmission point (TP), or a new generation NodeB (gNodeB) in a long-term evolution (LTE) system, a next-radio (NR) system, or an authorized auxiliary access long-term evolution (LAA-LTE) system, etc.

It should be understood that, in the embodiments of the disclosure, devices having communication functions in the network/system may be referred to as communication devices. Taking the communication system shown in FIG. 1 as an example, the communication devices may include network devices and terminal devices having communication functions, and the network devices and terminal devices may be the specific devices in the embodiments of the disclosure, which will not be repeated here; the communication devices may also include other devices in the communication system, such as a network controller, a mobility management entity, etc., which is not limited in the embodiments of the disclosure.

It should be understood that, in the disclosure, the terms “system” and “network” are often used interchangeably. The term “and/or” in the disclosure is merely a description of an association relationship between associated objects, indicating that three relationships may exist, for example, A and/or B may indicate that A exists alone, A and B exist simultaneously, or B exists alone. In addition, the character “/” in the disclosure generally indicates that the associated objects are in an “or” relationship.

It should be understood that, in the embodiments of the disclosure, “indication” may be direct indication, indirect indication, or indication of an association relationship. For example, A indicates B, which may mean that A directly indicates B, for example, B may be obtained through A; may also mean that A indirectly indicates B, for example, A indicates C, and B may be obtained through C; may also mean that there is an association relationship between A and B.

In the description of the embodiments of the disclosure, the term “correspond” may indicate that there is a direct correspondence or an indirect correspondence between the two, may also indicate that there is an association relationship between the two, and may also indicate an indication/indicated, configuration/configured relationship.

To facilitate understanding of the technical solutions of the embodiments of the disclosure, the related technologies of the embodiments of the disclosure are described below. The following related technologies are optional solutions and may be combined arbitrarily with the technical solutions of the embodiments of the disclosure, and all fall within the protection scope of the embodiments of the disclosure.

This disclosure is applicable to a mobile network, that is, a cellular network, and is described below taking a 5G network as an example, but the disclosure is not limited to the 5G network and may also be used in future mobile networks, such as a 6G network, etc.

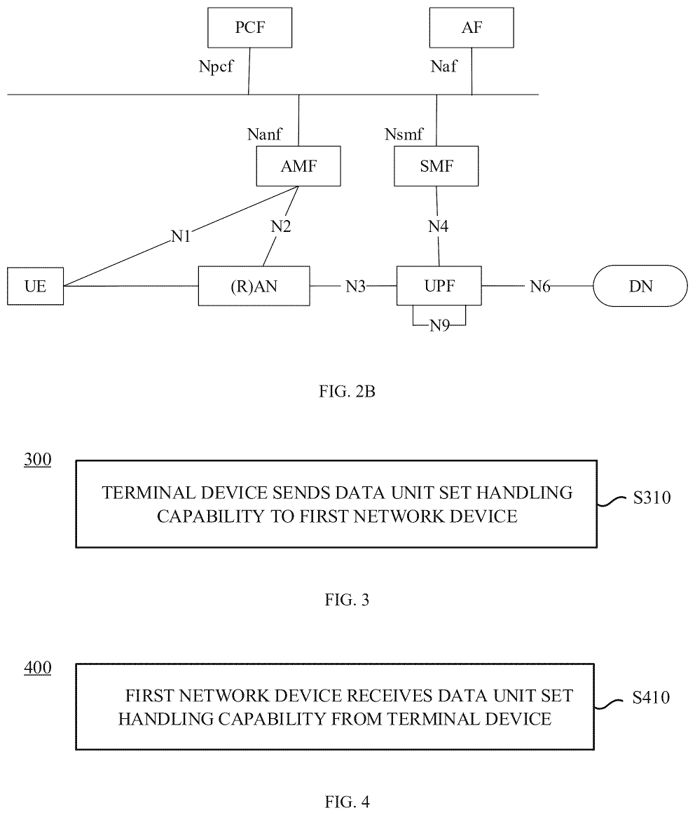

FIG. 2A and FIG. 2B are schematic diagrams of a 5G network system architecture. In the system architecture shown in FIG. 2A, the core network adopts a network-element interface mode; in the system architecture shown in FIG. 2B, the core network adopts a network-element service-based mode. In FIG. 2A, the core-network network elements are connected pairwise via predefined interfaces; in FIG. 2B, the core-network network elements interact by invoking services provided by the network elements. A UE establishes an access-stratum connection with an access network (AN) via a Uu interface to exchange access-stratum messages and wireless data transmission, and establishes a non-access-stratum (NAS) connection with an AMF via an N1 interface to exchange NAS messages. The AMF is a mobility-management function in the core network, the SMF is a session-management function in the core network, and in addition to mobility management for the UE, the AMF is also responsible for forwarding session-management-related messages between the UE and the SMF. The PCF is a policy-management function in the core network, responsible for formulating policies related to mobility management, session management, accounting, etc. for the UE. The UPF is a user-plane function in the core network, sends data with an external data network via an N6 interface, and sends data with the AN via an N3 interface. After the UE accesses the 5G network via the Uu interface, it establishes a protocol data unit (PDU) session under the control of the SMF to perform data transmission. The method proposed in the embodiments of the disclosure is applicable to the network architectures shown in FIG. 2A and FIG. 2B, but is not limited thereto .0062

In the related art, the UE may establish a PDU session through a network element to exchange application-layer data with an application server or with a peer UE through the application server, such as extended reality (XR) services, including augmented reality (AR) technology, virtual reality (VR) technology, cloud gaming, etc. To support transmission optimization for XR services, a core-network network element may determine multiple data packets belonging to one frame or coding slice, which in a 5G network are referred to as belonging to one data unit set (or data set), so that the 5G network can perform unified handling on multiple data packets belonging to one data unit set, for example, perform data unit set-level Quality of Service (QOS) processing, or if one data packet in a data unit set is lost, abandon transmission of the remaining data packets in the data unit set, etc.

To support data unit set handling, the SMF sends QOS parameters of the data unit set (for example, delay budget of the data unit set or error rate of the data unit set) to the access-network device, and the QoS parameters of the data unit set apply both to uplink data and to downlink data. However, data unit set handling for uplink data requires support from the UE, and not every UE supports data unit set handling. Therefore, for a UE that does not support data unit set handling, although the SMF provides the QoS parameters of the data unit set to the access-network device, the access-network device cannot correctly control the UE to perform data unit set handling, thereby affecting data transmission and user experience.

An embodiment of the disclosure proposes a communication method. FIG. 3 is a schematic flow chart of a communication method 300 according to an embodiment of the disclosure. The method may be applied to the system shown in FIG. 1, FIG. 2A, or FIG. 2B, but is not limited thereto. The method includes at least part of the following content.

S310: A terminal device sends a data unit set handling capability to a first network device.

In some embodiments, the data unit set handling capability may be used to indicate that the terminal device supports data unit set handling or does not support data unit set handling.

In some embodiments, the first network device may include an access and mobility management function (AMF).

Each of multiple terminal devices sends its own data unit set handling capability (for example, supports/does not support data unit set handling) separately to the AMF located in the core network. Subsequently, the session management function (SMF) in the core network may obtain the data unit set processing capability of each of multiple terminal devices from the AMF or from other core-network network elements (such as a unified data management (UDM) or a unified data repository (UDR)). Subsequently, the SMF may send data unit set handling information to the access-network device only for a terminal having the data unit set handling capability, for example, instruct the access-network device to perform data unit set handling for a QoS flow of the UE (the UE having the data unit set handling capability), or send QoS parameters of the data unit set for the QoS flow of the UE to the access-network device. In this way, only for a terminal having the data unit set handling capability will the access-network device obtain the data unit set handling information, and therefore can perform data unit set handling or QoS control on data of the terminal.

For example, the manner in which the terminal device sends the data unit set handling capability to the first network device may include: the terminal device sending a PDU session establishment request message/a PDU session modification request message to the first network device. The PDU session establishment request message/the PDU session modification request message carries the data unit set handling capability of the terminal device.

Subsequently, the first network device may forward the PDU session establishment request message/the PDU session modification request message to the SMF, thereby sending the data unit set handling capability of the terminal device to the SMF.

As another example, the manner in which the terminal device sends the data unit set handling capability to the first network device may include: the terminal device sending a registration request message to the first network device. The registration request message carries the data unit set handling capability of the terminal device. Alternatively, the terminal device sends a mobility-management-related request message to the first network device. The mobility-management-related request message carries the data unit set handling capability of the terminal device.

Subsequently, the first network device may obtain the data unit set handling capability of the terminal device from the registration request message or the mobility-management-related request message, store the data unit set handling capability of the terminal device, or send the data unit set handling capability of the terminal device to another core-network network element (such as a UDM or a UDR), hereinafter referred to as a second network element. Thereafter, the first network device may actively provide the data unit set handling capability of the terminal device to the SMF, or the SMF may query the data unit set handling capability of the terminal device from the first network device or the second network element.

In this way, the SMF obtains the data unit set processing capability of each of multiple terminal devices. Thus, the SMF may send data unit set handling information to the access-network device only for a terminal having the data unit set handling capability, for example, instruct the access-network device to perform data unit set handling for a QoS flow of the UE, or send QoS parameters of the data unit set for the QoS flow of the UE to the access-network device, so that the access-network device performs data unit set handling or QoS control only on data of a terminal having the data unit set handling capability, thereby guaranteeing data transmission and good user experience.

In other embodiments, the first network device may include an access-network device.

Before the terminal device sends the data unit set handling capability to the access-network device, the terminal device may receive first configuration information, the first configuration information includes data unit set configuration information. For example, the terminal device receives the first configuration information from the access-network device.

Before the access-network device sends the first configuration information to the terminal device, the access-network device may receive data unit set handling information from the SMF, for example, indication information for indicating to the access-network device to perform data unit set handling for a QoS flow of the UE, or QoS parameters of the data unit set for the QoS flow of the UE. When sending the data unit set handling information, the SMF does not know which UEs have the data unit set handling capability (i.e., support data unit set handling) and which UEs do not have the data unit set handling capability (i.e., do not support data unit set handling); instead, the SMF sends the data unit set handling information to one or more access-network devices of multiple UEs, where each of multiple UEs may or may not support data unit set handling. Subsequently, the one or more access-network devices send the first configuration information to the UEs respectively, the first configuration information including data unit set configuration information.

In some embodiments, after the terminal device receiving the first configuration information, if the terminal device itself has the data unit set handling capability, the terminal device sends feedback information for the first configuration information to the access-network device, the feedback information indicates that the terminal device supports data unit set handling.

In some embodiments, after the terminal device receiving the first configuration information, if the terminal device itself does not have the data unit set handling capability, the terminal device will not give any feedback to the first configuration information, i.e., will not send feedback information for the first configuration information to the access-network device. If the access-network device does not receive the feedback information for the first configuration information, the access-network device can thereby know that the terminal device does not have the data unit set handling capability; in this case, the access-network device may switch back to ordinary data packet-based handling or QoS control, and no longer use data unit set-based handling or QoS control.

Through this embodiment, after obtaining the data unit set handling information, the access-network device can learn whether the UE has the data unit set handling capability according to the feedback from the UE, and therefore can perform data unit set-based handling or QoS control on data of the terminal.

The disclosure further proposes a communication method. FIG. 4 is a schematic flow chart of a communication method 400 according to an embodiment of the disclosure. The method may be applied to the system shown in FIG. 1, FIG. 2A, or FIG. 2B, but is not limited thereto. The method includes at least part of the following content.

S410: A first network device receives a data unit set handling capability from a terminal device.

In some embodiments, the data unit set handling capability may indicate that the terminal device supports data unit set handling or does not support data unit set handling.

In some embodiments, the first network device may include an AMF.

In some embodiments, the first network device receiving the data unit set handling capability from the terminal device may include: the first network device receiving a PDU session establishment request message/a PDU session modification request message from the terminal device, the PDU session establishment request message/the PDU session modification request message carrying the data unit set handling capability.

Subsequently, the first network device may further send the PDU session establishment request message/the PDU session modification request message to a first network element, thereby reporting the data unit set handling capability of the terminal device to the first network element.

The first network element may include an SMF.

In some embodiments, the first network device receiving the data unit set handling capability from the terminal device may include: the first network device receiving a registration request message or a mobility-management-related request message from the terminal device, the registration request message or the mobility-management-related request message carries the data unit set handling capability.

Subsequently, the first network device may further obtain the data unit set handling capability from the registration request message or the mobility-management-related request message; thereafter, the first network device may store the data unit set handling capability, or send the data unit set handling capability to a second network element for storage. The second network element may include a UDM or a UDR.

Subsequently, the first network device may actively send the data unit set handling capability to the first network element. Alternatively, the first network element may also query the data unit set handling capability of the terminal device from the first network device or the second network element. The first network element may include an SMF.

In this way, through the above multiple manners, the first network device can provide the data unit set processing capabilities received from multiple terminal devices to the first network element directly or indirectly, so that the first network obtains the data unit set processing capabilities of multiple terminal devices. On this basis, the first network element may send data unit set handling information to the access-network device only for a terminal having the data unit set handling capability, for example, instruct the access-network device to perform data unit set handling for a QoS flow of the UE, or send QoS parameters of a data unit set(s) for the QoS flow of the UE to the access-network device. Therefore, it can be ensured that the access-network device performs data unit set-based handling or QoS control only on data of a terminal having the data unit set handling capability.

In other embodiments, the first network device may include an access-network device.

Before the access-network device receives the data unit set handling capability from the terminal device, the method may further include: the access-network device receiving data unit set handling information from the first network element. The data unit set handling information may include at least one of: indication information indicating to perform data unit set handling for a QoS flow of the terminal device; QoS parameters of the data unit set for the terminal device.

Thereafter, the access-network device sends first configuration information to the terminal device, the first configuration information including data unit set configuration information.

Correspondingly, the access-network device receiving the data unit set handling capability from the terminal device may include: the access-network device receiving feedback information for the first configuration information from the terminal device, the feedback information indicates that the terminal device supports data unit set handling. If the access-network device does not receive the feedback information for the first configuration information from the terminal device, it indicates that the terminal device does not support data unit set handling.

In this way, after obtaining the data unit set handling information, the access-network device can learn whether the UE has the data unit set handling capability according to feedback from the UE, and therefore can perform data unit set-based handling or QoS control only on the terminal having the data unit set handling capability.

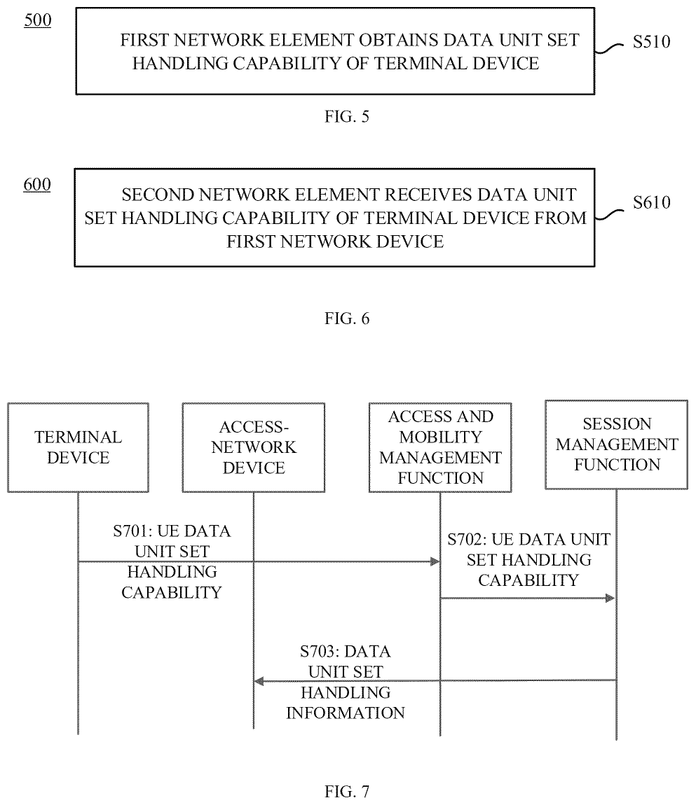

The disclosure further proposes a communication method. FIG. 5 is a schematic flow chart of a communication method 500 according to an embodiment of the disclosure. The method may be applied to the system shown in FIG. 1, FIG. 2A, or FIG. 2B, but is not limited thereto. The method includes at least part of the following content.

S510: A first network element obtains a data unit set handling capability of a terminal device.

In some embodiments, the data unit set handling capability may indicate that the terminal device supports data unit set handling or does not support data unit set handling.

The first network element may include an SMF.

The first network element may obtain the data unit set handling capability of the terminal device in various manners.

For example, in some embodiments, the first network element may receive the data unit set handling capability of the terminal device from a first network device. The first network device may include an AMF. The first network device may receive the data unit set handling capability of each of multiple terminal devices respectively from multiple terminal devices, and send the data unit set processing capability of each terminal device to the first network element.

As another example, in some embodiments, the first network element may query the data unit set handling capability of the terminal device from a first network device or a second network element. The second network element may include a UDM or a UDR. Before this, the first network device may receive the data unit set handling capability of each of multiple terminal devices respectively from the multiple terminal devices, store the data unit set processing capability of each terminal device, or send the data unit set processing capabilities of multiple terminal devices to the second network element for storage.

Through the above multiple manners, the first network element is able to obtain the data unit set processing capabilities of multiple terminal devices. On this premise, the first network element may send data unit set handling information to the access-network device only for a terminal having the data unit set handling capability, for example, instruct the access-network device to perform data unit set handling for a QoS flow of the UE, or send QoS parameters of the data unit set for the QoS flow of the UE to the access-network device. Therefore, it can be ensured that the access-network device performs data unit set-based handling or QoS control only on the terminal having the data unit set handling capability.

In some embodiments, the first network element may receive the data unit set handling capability of the terminal device from the access-network device.

For example, before receiving the data unit set handling capability of the terminal device, the first network element may send data unit set handling information to the access-network device of the terminal device. The data unit set handling information may include at least one of: indication information for indicating to perform data unit set handling for a QoS flow of the terminal device; QoS parameters of the data unit set for the terminal device.

Thereafter, the first network element receives feedback information for the first configuration information from the access-network device, the feedback information indicates that the terminal device supports data unit set handling. The first configuration information includes data unit set configuration information. If the first network element does not receive the feedback information for the first configuration information from the access-network device, it indicates that the corresponding terminal device does not support data unit set handling.

Based on the above embodiments, the disclosure further proposes a communication method. FIG. 6 is a schematic flow chart of a communication method 600 according to an embodiment of the disclosure. The method may be applied to the system shown in FIG. 1, FIG. 2A, or FIG. 2B, but is not limited thereto. The method includes at least part of the following content.

S610: A second network element receives a data unit set handling capability of a terminal device from a first network device.

In some embodiments, the data unit set handling capability indicates that the terminal device supports data unit set handling or does not support data unit set handling.

The second network element may include a UDM or a UDR. The first network device may include an AMF. The first network device may receive the data unit set handling capability of each of multiple terminal devices respectively from multiple terminal devices, and send the data unit set processing capability of each terminal devices to the second network element for storage.

After receiving the data unit set handling capability of the terminal device, the second network element may provide the data unit set handling capability of the terminal device to the first network element. The first network element may include an SMF.

In this way, the first network element is enabled to obtain the data unit set processing capability of each of multiple terminal devices. On this premise, the first network element may send data unit set handling information to the access-network device only for a terminal having the data unit set handling capability, for example, instruct the access-network device to perform data unit set handling for a QoS flow of the UE, or send QoS parameters of the data unit set for the QoS flow of the UE to the access-network device. Therefore, it can be ensured that the access-network device performs data unit set-based handling or QoS control only on the terminal having the data unit set handling capability.

The following describes the disclosure in detail with reference to the accompanying drawings and specific embodiments.

### Embodiment 1

In this embodiment, for example, the first network device is an AMF and the first network element is an SMF. It should be noted that the first network device, the first network element, etc. may also be other network elements or devices, and this embodiment does not list them one by one. The embodiment of the disclosure may be applied to a 5G mobile communication network, and may also be applied to other mobile networks, such as a 6G network, etc.

FIG. 7 is a flow chart of embodiment 1 of a communication method according to an embodiment of the disclosure, including the following steps.

S701: A terminal device sends its own data unit set handling capability (for example, supports/does not support data unit set handling) to the AMF located in the core network. Specifically, at least one of the following methods may be adopted.
(1) The terminal device carries its own data unit set handling capability in a PDU session establishment request message or a PDU session modification request message and sends it to the AMF.
(2) The terminal device carries its own data unit set handling capability in a registration request message or a mobility-management-related request message and sends it to the AMF.

S702: The SMF obtains the data unit set handling capability of the terminal from the AMF. Specifically, at least one of the following methods may be adopted.
(1) The AMF forwards the PDU session establishment request message or the PDU session modification request message carrying the data unit set handling capability of the terminal to the SMF.
(2) The AMF obtains the data unit set handling capability of the terminal device from the registration request message or the mobility-management-related request message; thereafter, the AMF stores the data unit set handling capability of the terminal in a UE context. Subsequently, the AMF actively provides the data unit set handling capability of the terminal to the SMF, or the SMF queries the data unit set handling capability of the terminal from the AMF.

S703: The SMF has obtained the data unit set handling capability of the terminal through step S702, and therefore sends data unit set handling information to the access-network device only for a terminal having the data unit set handling capability, for example, instructs the access-network device to perform data unit set handling for a QoS flow of the UE, or sends QoS parameters of the data unit set for the QoS flow of the UE to the access-network device, such as data unit set delay budget (PSDB), data unit set error rate (PSER), etc.

Through this embodiment, only for a terminal having the data unit set handling capability will the access-network device obtain the data unit set handling information, and therefore can perform data unit set-based handling or QoS control on data of the terminal.

### Embodiment 2

In this embodiment, for example, the first network device is an AMF, the first network element is an SMF, and the second network element is a UDM or a UDR. It should be noted that the first network device, the first network element, and the second network element, etc. may also be other network elements or devices, and this embodiment does not list them one by one. The embodiment of the disclosure may be applied to a 5G mobile communication network, and may also be applied to other mobile networks, such as a 6G network, etc.

FIG. 8 is a flow chart of embodiment 2 of a communication method according to an embodiment of the disclosure, including the following steps.

S801: A terminal device sends its own data unit set handling capability (for example, supports/does not support data unit set handling) to the AMF located in the core network. Specifically, the following is included: the terminal device carries its own data unit set handling capability in a registration request message or a mobility-management-related request message and sends it to the AMF.

S802: The AMF obtains the data unit set handling capability of the terminal device from the registration request message or the mobility-management-related request message, and sends the data unit set handling capability of the terminal device to the UDM or the UDR for storage by the UDM or the UDR.

S803: The SMF queries the data unit set handling capability of the terminal from the UDM or the UDR.

In this way, the SMF has obtained the data unit set processing capabilities of multiple terminal devices through the above process, and therefore can send data unit set handling information to the access-network device only for a terminal having the data unit set handling capability, for example, instruct the access-network device to perform data unit set handling for a QoS flow of the UE, or send QoS parameters of the data unit set for the QoS flow of the UE to the access-network device, such as PSDB, PSER, etc.

Through this embodiment, only for a terminal having the data unit set handling capability will the access-network device obtain the data unit set handling information, and therefore can perform data unit set-based handling or QoS control on data of the terminal.

### Embodiment 3

In this embodiment, for example, the first network device is an access-network device and the first network element an SMF. It should be noted that the first network device, the first network element, etc. may also be other network elements or devices, and this embodiment does not list them one by one. The embodiment of the disclosure may be applied to a 5G mobile communication network, and may also be applied to other mobile networks, such as a 6G network, etc.

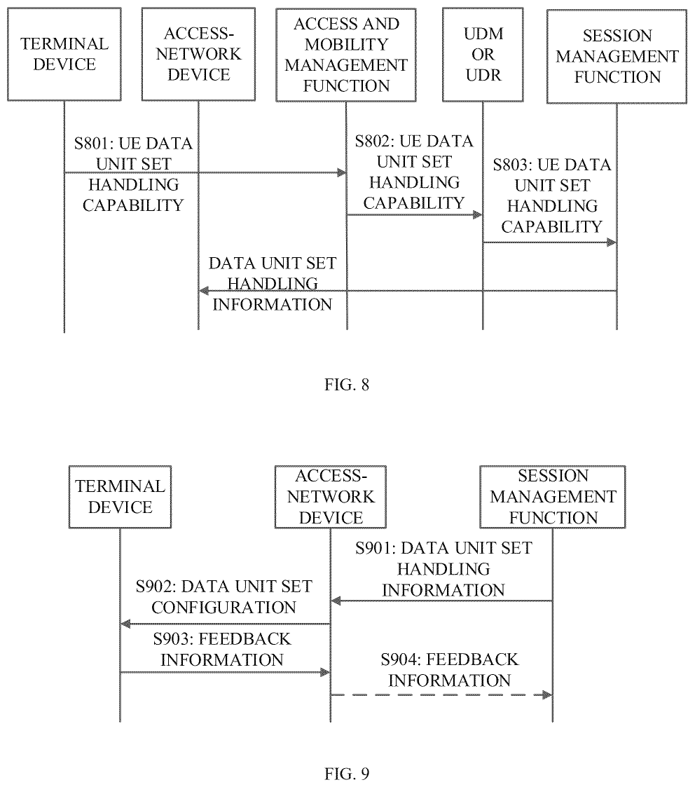

FIG. 9 is a flow chart of embodiment 3 of a communication method according to an embodiment of the disclosure, including the following steps.

S901: The SMF sends data unit set handling information to the access-network device, for example, instructs the access-network device to perform data unit set handling for a QoS flow of the UE, or includes QoS parameters of a data unit set for the QoS flow of the UE. When the SMF sends the data unit set handling information to the access-network device, it does not know which UEs have the data unit set handling capability and which UEs do not have the data unit set handling capability.

S902: According to the information received from the SMF, the access-network device determines to perform data unit set handling for the UE, and therefore configures corresponding data unit set control information to the UE. For example, the first network device (such as the access-network device) sends first configuration information to the terminal, the first configuration information includes data unit set configuration information.

S903: If the terminal has the data unit set handling capability, it feeds back successful configuration to the access-network device, for example, sends feedback information for the first configuration information to the access-network device, the feedback information indicates that the terminal device supports data unit set handling. In this embodiment, sending the feedback information indicates that the terminal device supports data unit set handling; rather than carrying, in the feedback information, information indicating that the terminal device supports data unit set handling. In some embodiments, the feedback information sent by the terminal device may further carry first indication information, the first indication information indicates agreement/disagreement with the access-network device's control of the data unit set; disagreeing with the access-network device's control of the data unit set does not mean that the terminal device does not have the data unit set handling capability. That is, the terminal device may, while having the data unit set handling capability, agree with the access-network device's control of the data unit set or disagree with the access-network device's control of the data unit set. Whether to agree may be decided according to the terminal device's own condition. In addition, if the terminal device disagrees with the access-network device's control of the data unit set, the feedback information may further include reasons for the access-network device's control failure over the terminal device, requirements of the terminal device, etc.

If the terminal device does not have the data unit set handling capability, it will not understand the data unit set control information in step S902 and therefore will not send a feedback. In this embodiment, not sending the feedback information indicates that the terminal device does not support data unit set handling.

Subsequently, if the access-network device receives the feedback information, it may continue to perform data unit set-based handling or QoS control; if it does not receive the feedback information, it may switch back to ordinary data packet-based handling or QoS control, and no longer use data unit set-based handling or QoS control. Here, ordinary data packet-based handling or QoS control may refer to handling or QoS control performed on each data packet individually; data unit set-based handling or QoS control may refer to unified handling or QoS control performed on multiple data packets belonging to one data unit set.

S904: According to the feedback from the terminal device, the access-network device may further feed back to the SMF to perform data unit set handling or to perform ordinary data packet handling. For example, the access-network device sends the feedback information for the first configuration information to the SMF, the feedback information indicates that the terminal device supports data unit set handling; in this way, the SMF receives the data unit set handling capability of the terminal device from the access-network device. This step is optional.

Through this embodiment, after obtaining the data unit set handling information, the access-network device learns whether the UE has the data unit set handling capability according to feedback from the UE, and therefore can perform data unit set handling or QoS control on data of the terminal.

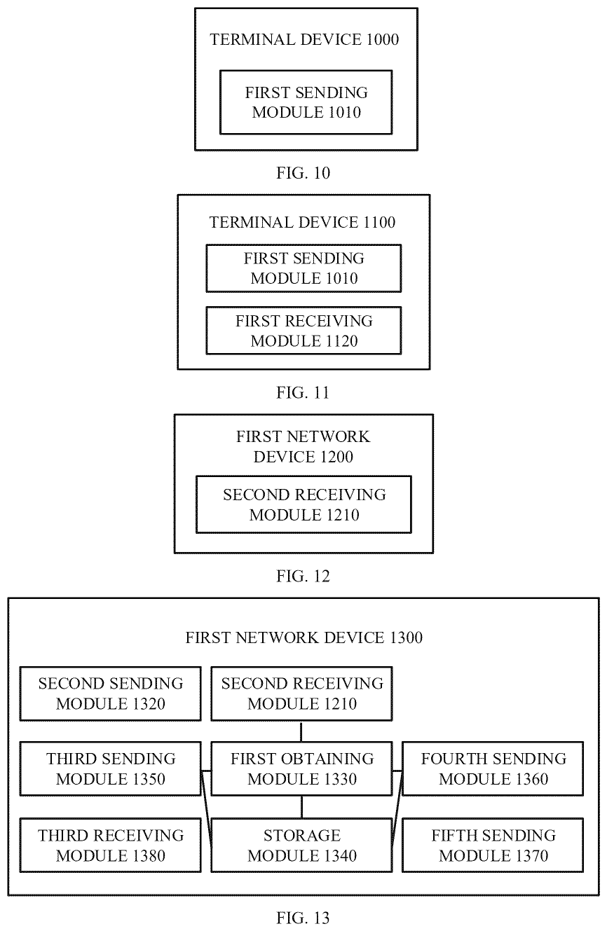

The embodiments of the disclosure further propose a terminal device. FIG. 10 is a schematic structural diagram of a terminal device 1000 according to an embodiment of the disclosure. The terminal device 1000 includes: a first sending module 1010 configured to send a data unit set handling capability to a first network device.

In some embodiments, the data unit set handling capability indicates that the terminal device supports data unit set handling or does not support data unit set handling.

In some embodiments, the first sending module 1010 is configured to send a PDU session establishment request message/a PDU session modification request message to the first network device, the PDU session establishment request message/the PDU session modification request message carries the data unit set handling capability.

In some embodiments, the first sending module 1010 is configured to send a registration request message to the first network device, the registration request message carries the data unit set handling capability.

In some embodiments, the first sending module 1010 is configured to send a mobility-management-related request message to the first network device, the mobility-management-related request message carries the data unit set handling capability.

In some embodiments, the first network device includes an access and mobility management function (AMF).

FIG. 11 is a schematic structural diagram of a terminal device 1100 according to an embodiment of the disclosure. The terminal device 1100 includes one or more features of the terminal device 1000 of the above embodiment. In one possible implementation, in the embodiments of the disclosure, prior to the first sending module 1010, the terminal device 1100 further includes: a first receiving module 1120 configured to receive first configuration information, the first configuration information includes data unit set configuration information.

In some embodiments, the first receiving module 1120 is configured to receive the first configuration information from an access-network device.

In some embodiments, the first sending module 1010 is configured to send feedback information for the first configuration information to the first network device, the feedback information indicates that the terminal device supports data unit set handling.

In some embodiments, the first network device includes an access-network device.

It should be understood that the above and other operations and/or functions of the modules in the terminal device according to the embodiments of the disclosure are respectively for implementing the corresponding processes of the terminal device in the method 300 in FIG. 3. For brevity, they are not repeated here.

The embodiments of the disclosure further propose a first network device. FIG. 12 is a schematic structural diagram of a first network device 1200 according to an embodiment of the disclosure. The first network device 1200 includes: a second receiving module 1210 configured to receive a data unit set handling capability from a terminal device.

In some embodiments, the data unit set handling capability indicates that the terminal device supports data unit set handling or does not support data unit set handling.

In some embodiments, the second receiving module 1210 is configured to receive a PDU session establishment request message/a PDU session modification request message from the terminal device, the PDU session establishment request message/the PDU session modification request message carries the data unit set handling capability.

FIG. 13 is a schematic structural diagram of a first network device 1300 according to an embodiment of the disclosure. The first network device 1300 includes one or more features of the first network device 1200 of the above embodiment. In one possible implementation, in the embodiments of the disclosure, the first network device 1300 further includes: a second sending module 1320 configured to send a PDU session establishment request message/a PDU session modification request message to a first network element.

In some embodiments, the second receiving module 1210 is configured to receive a registration request message or a mobility-management-related request message from the terminal device, the registration request message or the mobility-management-related request message carries the data unit set handling capability.

In some embodiments, the first network device 1300 further includes: a first obtaining module 1330 configured to obtain the data unit set handling capability from the registration request message or the mobility-management-related request message.

In some embodiments, the first network device 1300 further includes: a storage module 1340 configured to store the data unit set handling capability.

In some embodiments, the first network device 1300 further includes: a third sending module 1350 configured to send the data unit set handling capability to a first network element.

In some embodiments, the first network device 1300 further includes: a fourth sending module 1360 configured to send the data unit set handling capability to a second network element.

In some embodiments, the second network element includes a UDM or a UDR.

In some embodiments, the first network device includes an Access and Mobility Management Function (AMF).

In some embodiments, prior to the second receiving module 1210, the first network device 1300 further includes: a fifth sending module 1370 configured to send first configuration information to the terminal device, the first configuration information including data unit set configuration information.

In some embodiments, the second receiving module 1210 is configured to receive feedback information for the first configuration information from the terminal device, the feedback information indicates that the terminal device supports data unit set handling.

In some embodiments, prior to the fifth sending module 1370, the first network device 1300 further includes: a third receiving module 1380 configured to receive data unit set handling information from a first network element.

In some embodiments, the data unit set handling information includes at least one of: indication information for indicating to perform data unit set handling for a QoS flow of the terminal device; QoS parameters of the data unit set for the terminal device.

In some embodiments, the first network element includes a Session Management Function (SMF).

In some embodiments, the first network device includes an access-network device.

It should be understood that the above and other operations and/or functions of the modules in the first network device according to the embodiments of the disclosure are respectively for implementing the corresponding processes of the first network device in the method 400 in FIG. 4. For brevity, they are not repeated here.

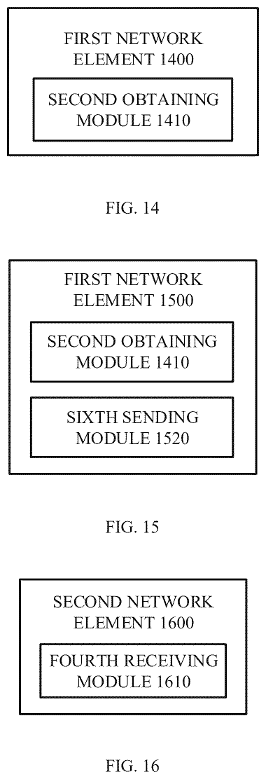

The embodiments of the disclosure further provide a first network element. FIG. 14 is a schematic structural diagram of a first network element 1400 according to an embodiment of the disclosure. The first network element 1400 includes: a second obtaining module 1410 configured to obtain a data unit set handling capability of a terminal device.

In some embodiments, the data unit set handling capability indicates that the terminal device supports data unit set handling or does not support data unit set handling.

In some embodiments, the second obtaining module 1410 is configured to receive the data unit set handling capability of the terminal device from a first network device.

In some embodiments, the second obtaining module 1410 is configured to query the data unit set handling capability of the terminal device from a first network device or a second network element.

In some embodiments, the second obtaining module 1410 is configured to receive the data unit set handling capability of the terminal device from an access-network device.

In some embodiments, the second obtaining module 1410 is configured to receive feedback information for first configuration information from the access-network device, the feedback information indicates that the terminal device supports data unit set handling; the first configuration information includes data unit set configuration information.

FIG. 15 is a schematic structural diagram of a first network element 1500 according to an embodiment of the disclosure. The first network element 1500 includes one or more features of the first network element 1400 of the above embodiment. In one possible implementation, in the embodiments of the disclosure, the first network element 1500 further includes: a sixth sending module 1520 configured to send data unit set handling information to the access-network device.

In some embodiments, the data unit set handling information includes at least one of: indication information for indicating to perform data unit set handling for a QoS flow of the terminal device; QoS parameters of the data unit set for the terminal device.

In some embodiments, the first network device includes an AMF.

In some embodiments, the second network element includes a UDM or a UDR.

In some embodiments, the first network element includes a Session Management Function (SMF).

It should be understood that the above and other operations and/or functions of the modules in the first network element according to the embodiments of the disclosure are respectively for implementing the corresponding processes of the first network element in the method 500 in FIG. 5. For brevity, they are not repeated here.

The embodiments of the disclosure further propose a second network element. FIG. 16 is a schematic structural diagram of a second network element 1600 according to an embodiment of the disclosure. The second network element 1600 includes: a fourth receiving module 1610 configured to receive a data unit set handling capability of a terminal device from a first network device.

In some embodiments, the data unit set handling capability indicates that the terminal device supports data unit set handling or does not support data unit set handling.

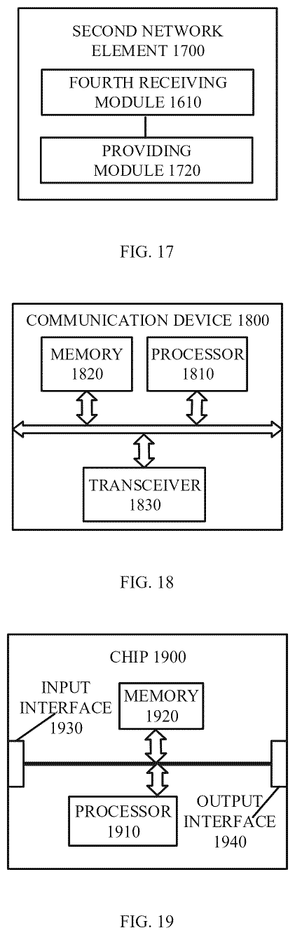

FIG. 17 is a schematic structural diagram of a second network element 1700 according to an embodiment of the disclosure. The second network element 1700 includes one or more features of the second network element 1600 of the above embodiment. In one possible implementation, in the embodiments of the disclosure, the second network element 1700 further includes: a providing module 1720 configured to provide the data unit set handling capability of the terminal device to a first network element.

In some embodiments, the second network element includes a UDM or a UDR.

In some embodiments, the first network device includes an Access and Mobility Management Function (AMF) or an access-network device.

In some embodiments, the first network element includes a Session Management Function (SMF).

It should be understood that the above and other operations and/or functions of the modules in the second network element according to the embodiments of the disclosure are respectively for implementing the corresponding processes of the second network element in the method 600 in FIG. 6. For brevity, they are not repeated here.

It should be noted that the functions described for the respective modules (sub-modules, units, or components, etc.) in the communication device of the embodiments of the disclosure may be implemented by different modules (sub-modules, units, or components, etc.), or may be implemented by the same module (sub-module, unit, or component, etc.). For example, the first receiving module and the second receiving module may be different modules or may be the same module, and both can implement their respective functions in the embodiments of the disclosure. In addition, the sending module and the receiving module in the embodiments of the disclosure may be implemented by a transceiver of the device, and part or all of the other modules may be implemented by a processor of the device.

FIG. 18 is a schematic structural diagram of a communication device 1800 according to an embodiment of the disclosure. As shown in FIG. 18, the communication device 1800 includes a processor 1810. The processor 1810 may invoke and run a computer program from a memory to implement the methods of the embodiments of the disclosure.

In some embodiments, as shown in FIG. 18, the communication device 1800 may further include a memory 1820. The processor 1810 may invoke and run the computer program from the memory 1820 to implement the communication device of the embodiments of the disclosure.

The memory 1820 may be a separate component independent of the processor 1810, or may be integrated into the processor 1810.

In some embodiments, as shown in FIG. 18, the communication device 1800 may further include a transceiver 1830. The processor 1810 may control the transceiver 1830 to communicate with other devices, and specifically may send information or data to other devices or receive information or data sent by other devices.

The transceiver 1830 may include a transmitter and a receiver. The transceiver 1830 may further include one or more antennas.

In some embodiments, the communication device 1800 may be the communication device of the embodiments of the disclosure, and the communication device 1800 may implement the corresponding processes in the various methods of the embodiments of the disclosure as performed by the communication device. For brevity, they are not repeated here.

FIG. 19 is a schematic structural diagram of a chip 1900 according to an embodiment of the disclosure. As shown in FIG. 19, the chip 1900 includes a processor 1910. The processor 1910 may invoke and run a computer program from a memory to implement the methods of the embodiments of the disclosure.

In some embodiments, as shown in FIG. 19, the chip 1900 may further include a memory 1920. The processor 1910 may invoke and run the computer program from the memory 1920 to implement the methods of the embodiments of the disclosure.

The memory 1920 may be a separate component independent of the processor 1910, or may be integrated into the processor 1910.

In some embodiments, the chip 1900 may further include an input interface 1930. The processor 1910 may control the input interface 1930 to communicate with other devices or chips, and specifically may obtain information or data sent by other devices or chips.

In some embodiments, the chip 1900 may further include an output interface 1940. The processor 1910 may control the output interface 1940 to communicate with other devices or chips, and specifically may output information or data to other devices or chips.

In some embodiments, the chip may be applied to the communication device of the embodiments of the disclosure, and the chip may implement the corresponding processes in the various methods of the embodiments of the disclosure as performed by the network device. For brevity, they are not repeated here.

It should be understood that the chip mentioned in the embodiments of the disclosure may also be referred to as a system-level chip, a system chip, a chip system, or an on-system chip, etc.

The above-mentioned processor may be a general-purpose processor, a digital signal processor (DSP), a field-programmable gate array (FPGA), an application specific integrated circuit (ASIC), or other programmable logic devices, discrete gate or transistor logic devices, discrete hardware components, etc. The above-mentioned general-purpose processor may be a microprocessor or any conventional processor.

The above-mentioned memory may be a volatile memory or a non-volatile memory, or may include both volatile and non-volatile memories. The non-volatile memory may be a read-only memory (ROM), a programmable read-only memory (PROM), an erasable programmable read-only memory (EPROM), an electrically erasable programmable read-only memory (EEPROM), or flash memory. The volatile memory may be a Random Access Memory (RAM).

It should be understood that the above-mentioned memories are exemplary and not restrictive. For example, the memories in the embodiments of the disclosure may also be a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM), or a direct rambus RAM (DRRAM), etc. That is to say, the memories in the embodiments of the disclosure are intended to include, but are not limited to, these and any other suitable types of memories.

In the above embodiments, the implementation may be carried out wholly or partly by software, hardware, firmware, or any combination thereof. When implemented by software, it may be wholly or partly implemented in the form of a computer program product. The computer program product includes one or more computer instructions. When the computer program instructions are loaded and executed on a computer, the processes or functions described in the embodiments of the disclosure are wholly or partly generated. The computer may be a general-purpose computer, a special-purpose computer, a computer network, or another programmable apparatus. The computer instructions may be stored in a computer-readable storage medium or transmitted from one computer-readable storage medium to another. For example, the computer instructions may be transmitted from a website, computer, server, or data center to another website, computer, server, or data center via wired (for example, coaxial cable, optical fiber, Digital Subscriber Line (DSL)) or wireless (for example, infrared, radio, microwave, etc.) means. The computer-readable storage medium may be any available medium that can be accessed by a computer or a data storage device such as a server or a data center that integrates one or more available media. The available medium may be a magnetic medium (for example, a floppy disk, a hard disk, or a magnetic tape), an optical medium (for example, a DVD), or a semiconductor medium (for example, a Solid State Disk (SSD)), etc.

It should be understood that, in the various embodiments of the disclosure, the sequence numbers of the above processes do not imply an order of execution. The execution order of the processes should be determined by their functions and inherent logic, and should not constitute any limitation on the implementation process of the embodiments of the disclosure.

Those of ordinary skill in the art may clearly understand that, for the convenience and brevity of description, the specific working processes of the systems, apparatuses, and units described above may refer to the corresponding processes in the foregoing method embodiments, and will not be repeated here.

The above is only a specific embodiment of the disclosure, but the protection scope of the disclosure is not limited thereby. Any person skilled in the art can easily think of changes or substitutions within the technical scope disclosed by the disclosure, and they shall be covered within the protection scope of the disclosure. Therefore, the protection scope of the disclosure shall be subject to the protection scope of the claims.

What is claimed is:

1. A terminal device, comprising:
a transceiver;
a processor; and
a memory storing computer programs which, when executed by the processor, are operable with the processor to:
cause the transceiver to send a data unit set handling capability to a first network device.

2. The terminal device of claim 1, wherein the data unit set handling capability indicates that the terminal device supports or does not support data unit set handling.

3. The terminal device of claim 1, wherein the transceiver configured to send the data unit set handling capability to the first network device is configured to perform one of:
sending, by the terminal device, a protocol data unit (PDU) session establishment request message/a PDU session modification request message to the first network device, wherein the PDU session establishment request message/the PDU session modification request message carries the data unit set handling capability; or
sending, by the terminal device, a registration request message to the first network device, wherein the registration request message carries the data unit set handling capability; or
sending, by the terminal device, a mobility-management-related request message to the first network device, wherein the mobility-management-related request message carries the data unit set handling capability.

4. The terminal device of claim 1, wherein the first network device comprises an access and mobility management function (AMF).

5. The terminal device of claim 1, wherein the transceiver is further configured to:
receive first configuration information, wherein the first configuration information comprises data unit set configuration information.

6. The terminal device of claim 5, wherein the transceiver configured to receive the first configuration information is configured to:
receive the first configuration information from an access network device.

7. The terminal device of claim 5, wherein the transceiver configured to send the data unit set handling capability to the first network device is configured to:
send feedback information for the first configuration information to the first network device, wherein the feedback information indicates that the terminal device supports data unit set handling.

8. A network device, comprising:
a transceiver;
a processor; and
a memory storing computer programs which, when executed by the processor, are operable with the processor to:
cause the transceiver to receive a data unit set handling capability from a terminal device.

9. The network device of claim 8, wherein the transceiver configured to receive the data unit set handling capability from the first network device is configured to:
receive a protocol data unit (PDU) session establishment request message/a PDU session modification request message from the terminal device, wherein the PDU session establishment request message/the PDU session modification request message carries the data unit set handling capability.

10. The network device of claim 9, wherein the transceiver is further configured to:
send the PDU session establishment request message/the PDU session modification request message to a first network element.

11. The network device of claim 8, wherein the transceiver configured to receive the data unit set handling capability from the terminal device is configured to:
receive a registration request message or a mobility-management-related request message from the terminal device, wherein the registration request message or the mobility-management-related request message carries the data unit set handling capability.

12. The network device of claim 11, wherein the processor is further configured to:
obtain the data unit set handling capability from the registration request message or the mobility-management-related request message.

13. The network device of claim 12, wherein the processor is further configured to:
store the data unit set handling capability in the memory.

14. The network device of claim 12, wherein the transceiver is configured to perform one of:
sending the data unit set handling capability to a first network element, or sending the data unit set handling capability to a second network element.

15. The network device of claim 14, wherein the second network element comprises a unified data management (UDM) or a unified data repository (UDR).

16. The network device of claim 8, wherein the transceiver is further configured to:
send first configuration information to the terminal device, wherein the first configuration information comprises data unit set configuration information.

17. The network device of claim 16, wherein the transceiver configured to receive the data unit set handling capability from the terminal device is configured to:
receive from the terminal device, feedback information for the first configuration information, wherein the feedback information indicates that the terminal device supports data unit set handling.

18. The network device of claim 16, wherein the transceiver is further configured to:
receive data unit set handling information from a first network element.

19. The network device of claim 18, wherein the data unit set handling information comprises at least one of:
indication information indicating to perform data unit set handling for a quality of service (QOS) flow of the terminal device; or
QoS parameters of a data unit set of the terminal device.

20. The network device of claim 10, wherein the first network element comprises a session management function (SMF), or, wherein the first network device comprises an access network device, or wherein the first network device comprises an access and mobility management function (AMF).
